(19) United States
(12) Patent Application Publication
(10) Pub. No.: US 2002/0143591 A1
(43) Pub. Date: Oct. 3, 2002

(54) Method and apparatus for a hybrid content on demand broadcast system

(76) Inventor: Jay H. Connelly, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,484

(22) Filed: Mar. 30, 2001

(51) Int. Cl. G06F 17/60; H04N 7/025; H04N 7/10; H04N 5/445

(52) U.S. Cl. 705/7; 348/563; 725/32

(57) ABSTRACT

A service provider broadcast system is described. The system combines service provider meta-data with broadcast service meta-data to form a combined meta-data set. The service provider meta-data includes a description of a first plurality of data files available from the system while the broadcast service meta-data includes descriptions of broadcast data files to be broadcast by the broadcast service. The system receives ratings of each of the data files described by the combined meta-data set. Using these ratings, the system selects a subset of the data files to generate a provider/broadcast data file subset. Using this subset, the system determines overlapping data files contained within the subset, which are to be broadcast by the broadcast service. The system then removes the overlapping data files from the subset in order to generate provider data files, which are broadcast to one or more client systems.

### FIELD OF THE INVENTION

The present invention relates generally to broadcast systems. In particular, the present invention relates to combining a digital broadcasting service with existing broadcast content to produce a hybrid content on demand broadcast system.

### BACKGROUND OF THE INVENTION

Broadcast systems traditionally transmit data in one direction—from a server system to a plurality of client systems. Users of the client systems typically consume the signals received from the server system as they are broadcast. One paradigm in which users are provided with content on demand involves server systems that broadcast the same data continuously and/or at staggered intervals. Thus, if a user desires to consume a particular data file on demand, the user “tunes in” to one of the repeated broadcasts of the data file.

One example of this paradigm can be illustrated with present day “pay per view” movies that are available from cable or satellite television providers. For instance, cable television providers commonly broadcast the same movies repeatedly on multiple channels at staggered intervals. Users that wish to watch a particular movie, “on demand,” simply tune in to one of the channels on which the desired movie is broadcast prior to a broadcast time of the movie. Unfortunately, these continuous and repeated broadcasts of the same data or programs results in a very inefficient use of broadcast bandwidth. Bandwidth used to broadcast the same data repeatedly on multiple channels could otherwise be used to broadcast different data.

Another paradigm for providing content on demand in a broadcast system involves a user recording a particular data file and later accessing the data file “on demand. For example, a user can set up his or her video cassette recorder (VCR) to record a desired television program. Later, when the user wishes to watch the television program, “on demand,” the user simply plays the earlier recorded program from his or her VCR. Recently, more advanced digital video recorders have become available, which record television broadcasts on internal hard drives instead of the video cassette tapes used by traditional VCRs. However, use of the digital video recorders is similar to traditional VCRs in that the users are required to explicitly set the criteria used (e.g. date, time) to determine which broadcasts are recorded on the internal hard drives.

Another limitation with present day broadcast systems is that it is difficult for most users of the client systems to provide feedback to broadcasters with regard to programming. As an example, many of today's television broadcasters rely upon Neilson ratings to determine broadcast programming and/or scheduling. Neilson ratings are generally based upon only a small sampling of a cross-section of the public. Consequently, most television viewers have relatively little or no impact on broadcast schedules and/or content. In fact, the pay-per view movies available are certainly not based on user feedback. Furthermore, the user does not have a choice as to when to view a pay-per view event, and therefore must be available during the event broadcast date and time.

Therefore, there remains a need to overcome one or more of the limitations in the above-described, existing art.

### BRIEF DESCRIPTION OF THE DRAWINGS

The present invention is illustrated by way of example and not limitation in the accompanying figures.

FIG. 1 depicts a block diagram illustrating a broadcast service system as known in the art.

FIG. 2A depicts a block diagram illustrating a service provider broadcast system in accordance with one embodiment of the present invention.

FIG. 2B depicts a block diagram illustrating a service provider broadcast system in accordance with a further embodiment of the present invention.

FIG. 3 depicts a block diagram illustrating a computer system representative of a client or a server in accordance with an embodiment of the present invention.

FIG. 4 depicts a block diagram illustrating a service provider broadcast system in accordance with an exemplary embodiment of the present invention.

FIG. 5 depicts a flow chart illustrating the flow of events in a server and a client when combining existing broadcast content with cached content in order to produce a hybrid content-on-demand broadcast system in accordance with an embodiment of the present invention.

FIG. 6 depicts a flow diagram illustrating the flow of events in a server when combining existing broadcast content with cached content in order to reduce broadcast bandwidth in accordance with an embodiment of the present invention.

FIG. 7 is a flow diagram illustrating the flow of events performed by a client for storing a subset of data files selected by the service provider broadcast system in accordance with the further embodiment of the present invention.

FIG. 8 is a flow diagram illustrating additional events performed by a client when receiving a broadcast schedule in accordance with a further embodiment of the present invention.

FIG. 9 depicts a flow diagram illustrating additional events performed by a client when receiving a broadcast schedule for overlapping data files in accordance with the further embodiment of the present invention.

FIG. 10 is a flow diagram illustrating additional events performed by a client when a portion of data files are available from a server in accordance with a further embodiment of the present invention.

FIG. 11 is a flow diagram illustrating additional events performed by a client when receiving overlapping data files from a broadcast service system in accordance with a further embodiment of the present invention.

FIG. 12 depicts a flow diagram illustrating the flow of events in a client when processing meta-data broadcast from a server to maintain a meta-data table and content rating table in accordance with one embodiment of the present invention.

FIG. 13 is an illustration of one example of meta-data broadcast by a server to describe a in accordance with the teachings of the present invention.

FIG. 14 is an illustration of one example of a meta-data table updated and maintained by a client in accordance with the teachings of the present invention.

FIG. 15 is an illustration of one example of a content rating table updated and maintained by a client in accordance with the teachings of the present invention.

FIG. 16 depicts a diagram illustrating data files that are classified by a user in accordance with one embodiment of the present invention.

FIG. 17 depicts a diagram illustrating a meta-data table that is updated in response to user classifications in accordance with one embodiment of the present invention.

FIG. 18 is a diagram illustrating one embodiment of a meta-data table that is updated after a user access in accordance with the teachings of the present invention.

FIG. 19 is a diagram illustrating one embodiment of a content rating table that is updated after a user access in accordance with the teachings of the present invention.

FIG. 20 is a diagram illustrating another embodiment of a meta-data table that is updated after another user access in accordance with the teachings of the present invention.

### DETAILED DESCRIPTION OF THE INVENTION

A method and apparatus for a hybrid content on demand broadcast system are disclosed. In the following description, for the purposes of explanation, numerous specific details are set forth in order to provide a thorough understanding of the present invention. It will be apparent, however, to one skilled in the art that the present invention may be practiced without some of these specific details. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention. In other instances, well-known structures and devices are shown in block diagram form in order to avoid obscuring the details of the present invention.

In an embodiment, the method of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or other type of media/machine-readable medium suitable for storing electronic instructions. Moreover, the present invention may also be downloaded as a computer program product. As such, the program may be transferred from a remote computer (e.g., a server) to a requesting computer (e.g., a client) by way of data signals embodied in a carrier wave or other propagation medium via a communication link (e.g., a modem or network connection).

System Architecture

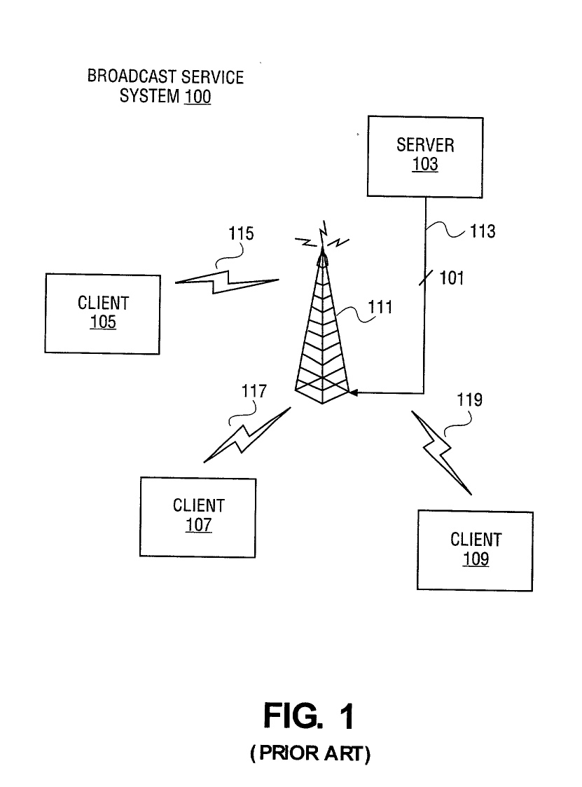

FIG. 1 is an illustration of one embodiment of a conventional broadcast service system 100, as known to those skilled in the art. The broadcast service system 100 includes a server 103 configured to broadcast information 101 to a plurality of clients 105, 107 and 109. Client 105 receives a broadcast from server 103 through a link 115 from a broadcast antenna 111. Similarly, client 107 receives a broadcast from server 103 through a link 117 and client 109 receives a broadcast from server 103 through a link 119 from broadcast antenna 111. Unfortunately, links 115, 117 and 119 are uni-directional wireless radio frequency (RF) links from broadcast antenna 111. Consequently, the broadcast service system 100 lacks the capability for enabling users of the client systems to provide feedback to broadcasters with regard to programming. Moreover, the broadcast service system 100 broadcasts the same data 101 continuously and/or at staggered intervals. Unfortunately, these continuous and repeated broadcasts of the same data or programs 101 results in a very inefficient use of broadcast bandwidth.

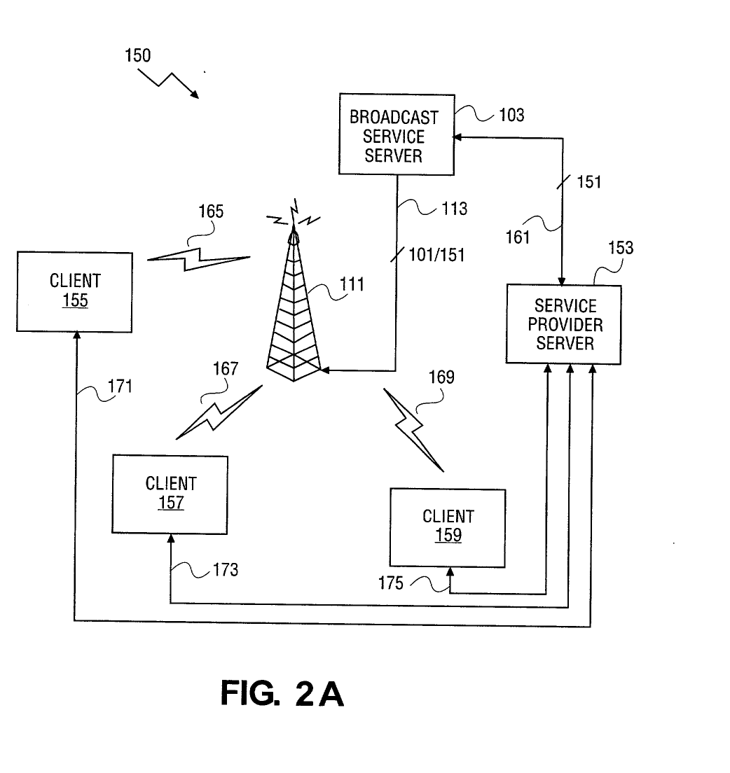

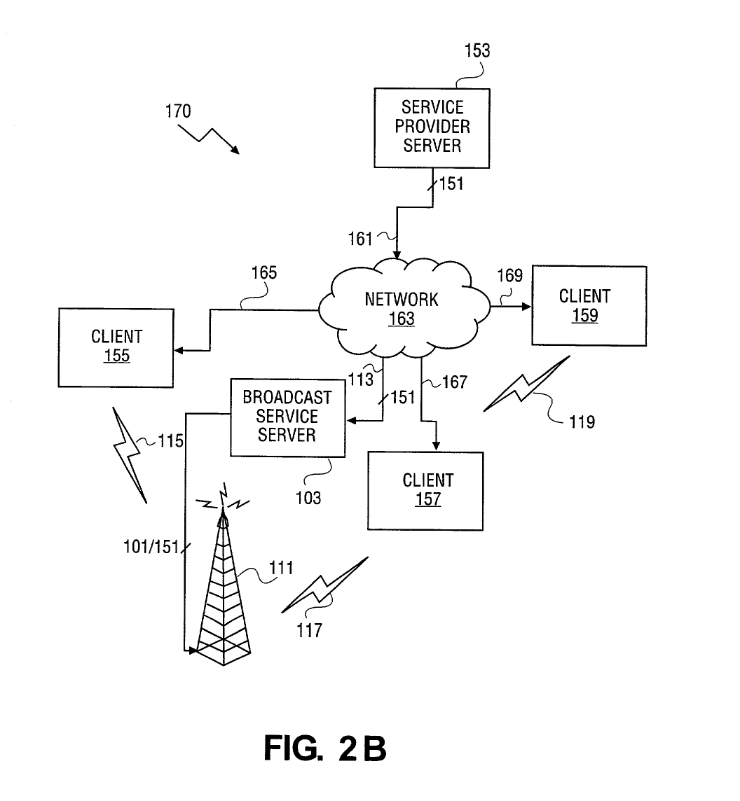

Referring now to FIG. 2A, a hybrid content on demand broadcast system (“service provider broadcast system”) 150 is depicted. The service provider broadcast system 150 is designed to work in conjunction with a standard broadcast system, such as the broadcast service system 100, as depicted in FIG. 1. As will be described in further detail below, the service provider broadcast system enables companies or broadcast systems who want to optimize bandwidth, pay-per view royalties or subscription fees to combine their existing broadcast content with a digital broadcasting/caching service provided by a service provider broadcast system.

The service provider broadcast system 150 is configured to broadcast information 151 to a plurality of clients 155, 157 and 159, for example, utilizing bandwidth provided by the broadcast service system 100. As such, the service provider broadcast system 150 transmits the information 151 to the broadcast server 103. The service provider information 151 along with the broadcast information 101 is then broadcast, via antenna 111, to the plurality of clients 155, 157 and 159. However, those skilled in the art will appreciate that the broadcast of information, as contemplated by the present invention, includes broadcast via cable, satellite, broadcast antenna or the like, as described in further detail below. Client 155 receives a broadcast from the broadcast server 103 through a link 165 from the broadcast antenna 111. Similarly, client 157 receives a broadcast from the broadcast server 103 through a link 167 and client 159 receives a broadcast from broadcast server 103 through a link 169 from broadcast antenna 111. In this embodiment, links 165, 167 and 169 are uni-direction, wireless radio frequency (RF links) from broadcast antenna 111. The format of such broadcasts is, for example but not limited to, known amplitude modification (AM) or frequency modification (FM) radio signals, television (TV) signals, digital video broadcasts (DVB) signals, or the like, which are broadcast through the atmosphere.

The broadcast server 103 is configured to broadcast a plurality of broadcast data files 101, which may be received by clients 155, 157 and 159. In addition, the broadcast server 103 allocates bandwidth to the service provider server 153 in order to broadcast a plurality of provider data files 151, which are also received by clients 155, 157 and 159. The data files 101/151 may include, for example, any combination of a number of different types of files including for example video, audio, graphics, text, multi-media or the like. For purposes of explanation, many of the examples provided in this disclosure assume that the data files to be broadcast by the server are audio/video files, such as for example movies with moving images and sound. However, it will be appreciated that the data files broadcast in accordance with the teachings of the present invention are not limited only to audio/video files.

As illustrated in FIG. 1, the broadcast service system 100 includes a one-way or unidirectional link between the server 103 and clients 105, 107 and 109. However, the service provider broadcast system 150, as depicted in FIG. 2A, includes a “back channel” or communications link between each of client 155, 157 and 159 and the service provider server 153. In particular, the service provider broadcast system 150 illustrated in FIG. 2A shows links 161, 163 and 165, which may be used by clients 155, 157 and 159, respectively, to send information back to service provider server 153 such as providing feedback to broadcasters regarding programming. Although links 161, 163 and 165 are illustrated in FIG. 2A as direct links between clients 155, 157 and 159 and service provider server 153, it is appreciated that clients 155, 157 and 159 may communicate information to the service provider server 153 through indirect links such as, for example, but not limited to broadcasted wireless signals, network communications or the like.

FIG. 2B is an illustration of a further embodiment of the service provider broadcast system 170 in accordance with the teachings of the present invention. As shown, the service provider server 153 utilizes bandwidth provided by the broadcast server 103 to broadcast information 151 to a plurality of clients 155, 157 and 159 through a network 163. In one embodiment, network 163 may be any type of communications network through which a plurality of different devices may communicate such as for example but not limited to the Internet, a wide area network (WAN), a local area network (LAN), an Intranet, an Extranet or the like.

In the embodiment illustrated in FIG. 2B, client 165 receives information 101/151 broadcast from broadcast server 103 through link 165. Similarly, client 157 receives information 101/151 broadcast from broadcast server 103 through link 167 and client 159 receives information 101/151 broadcast from the broadcast server 153 through link 169. It is noted that in the embodiment illustrated in FIG. 2B, links 165, 167 and 169 are shown as unidirectional links from network 163 to clients 155, 157 and 159, in which a back channel, as depicted in FIG. 2A, may be used to communicate information to the service provider server 153. In another embodiment, links 165, 167 and 169 are bi-directional links, which enable clients 155, 157 and 159 to communication information to the service provider server 153.

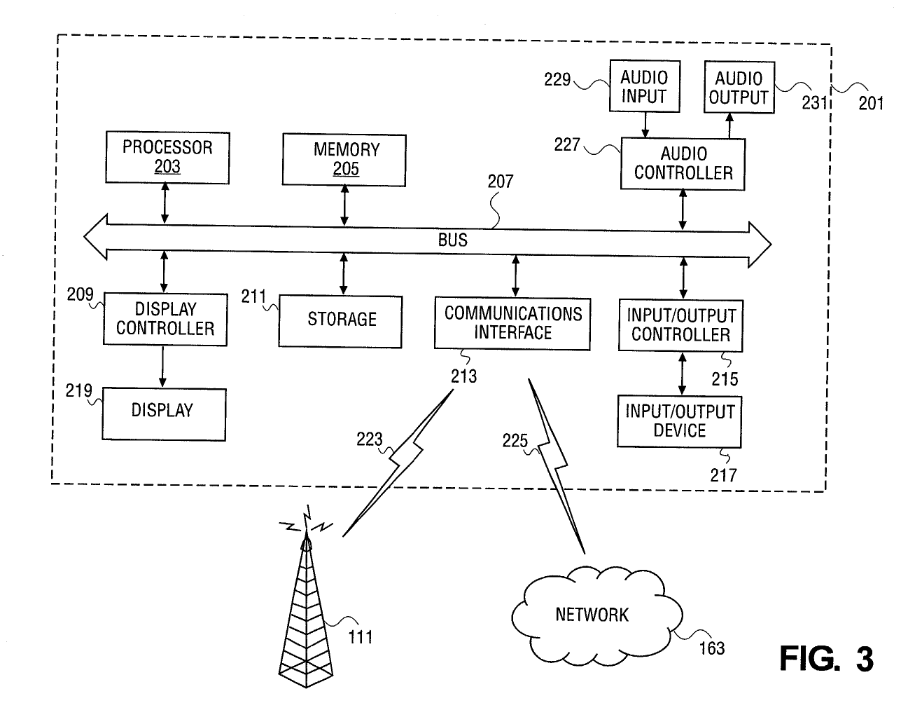

FIG. 3 is a block diagram illustrating one embodiment of a machine 201 that may be used for the service provider server 153, or clients 153, 155 or 157 in accordance with the teachings of the present invention. The machine 201 is, for example, a computer or a set top box that includes a processor 203 coupled to a bus 207. The machine 201 includes a memory 205, a storage 211, a display controller 209, a communications interface 213, an input/output controller 215 and an audio controller 227 are also coupled to bus 207.

In one embodiment, machine 201 interfaces to external systems through communications interface 213. Communications interface 213 may include, for example, a radio transceiver compatible with AM, FM, TV, digital TV, DVB, wireless telephone signals or the like. Communications interface 213 may also include, for example, an analog modem, Integrated Services Digital Network (ISDN) modem, cable modem, Digital Subscriber Line (DSL) modem, a T-1 line interface, a T-3 line interface, an optical carrier interface (e.g. OC-3), token ring interface, satellite transmission interface, a wireless interface or other interfaces for coupling a device to other devices.

A carrier wave signal 223 may be received by communications interface 213 to communicate with antenna 111. In addition, a carrier wave signal 225 may be received/transmitted between communications interface 213 and network 113. The carrier wave signal 225 may also be used to interface machine 201 with another computer system, a network hub, router or the like. The carrier wave signals 223 and 225 are, for example, considered to be machine readable media, which may be transmitted through wires, cables, optical fibers or through the atmosphere, or the like.

The processor 203 may be a conventional microprocessor, such as, for example, but not limited to an Intel x86 or Pentium family microprocessor, a Motorola family microprocessor, or the like. Memory 205 may be a machine readable medium such as dynamic random access memory (DRAM) and may include static random access memory (SRAM). Display controller 209 controls, in a conventional manner, a display 219, which may be a cathode ray tube (CRT), a liquid crystal display (LCD), an active matrix display, a television monitor or the like. The input/output device 217 coupled to input/output controller 215 may be, for example, a keyboard, disk drive, printer, scanner and other input and output devices, including a television remote, mouse, trackball, trackpad, joystick, or the like. In one embodiment, audio controller 227 controls in a conventional manner audio output 231, which may include for example audio speakers, headphones, an audio receiver, amplifier or the like. In addition, the audio controller may also control, in a conventional manner, audio input 229, which may include for example a microphone or input(s) from an audio or musical device, or the like.

The storage 211 may, for example, include machine readable media such as for example but not limited to a magnetic hard disk, a floppy disk, an optical disk, a smart card or another form of storage for data. Alternatively, the storage 211 may include, for example, removable media, read-only media, readable/writable media or the like. Some of the data may, for example, be written by a direct memory access process into memory 205 during execution of software in computer system 201. It is appreciated that software may reside in storage 211, memory 205 or may be transmitted or received via modem or communications interface 213. For the purposes of the specification, the term “machine readable medium” shall be taken to include any medium that is capable of storing data, information or encoding a sequence of instructions for execution by processor 203 to cause processor 203 to perform the methodologies of the present invention. The term “machine readable medium” shall be taken to include, but is not limited to solid-state memories, optical and magnetic disks, carrier wave signals, and the like.

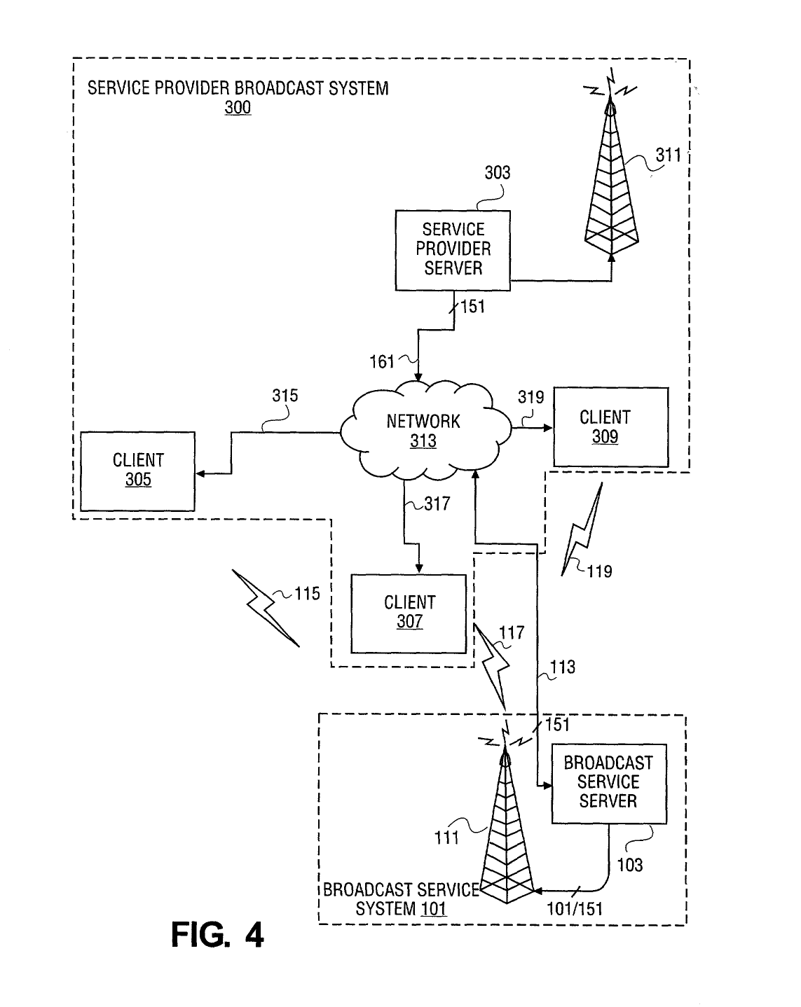

Referring now to FIG. 4, one embodiment of a service provider broadcast system 300, such as depicted in FIGS. 2A and 2B, is depicted. In one embodiment, the service provider broadcast system 300 is configured to have a service provider server 303 broadcast a plurality of provider data files 151 to a plurality of clients 305, 307 and 309 utilizing bandwidth provided by the broadcast server 103. The service provider broadcast system 300 utilizes content 101 broadcast by a broadcast service system, such as the broadcast service system 100 depicted in FIG. 1, in order to select the plurality of provider data files 151 broadcast to the clients 305, 307 and 309.

As described above, the broadcast service system 100 generally broadcasts the same data continuously and/or at staggered intervals to the system's clients, 105, 107 and 109 (FIG. 1). Utilizing the content broadcast by the broadcast service system 100, the service provider broadcast system 300 ranks the plurality of data files available from the system 300 and the broadcast data files 100. Once ranked, the system 300 selects a portion of the plurality of data files having, for example, a higher ranking (provider/broadcast data files). Once this portion is selected, the service provider broadcast system 300 eliminates data files from the provider/broadcast data file subset, which are to be broadcast by the broadcast service system 100 to form the plurality of provider data files 151. This plurality of provider data files 151 is then broadcast to the clients 305, 307 and 309 via the broadcast server 103. In addition, the client systems 305, 307 and 309 may be directed to store one or more broadcast data files 101 by the broadcast service system, as well as one or more of the plurality of provider data files 151. Procedural methods for performing the teaching of the present invention are now described.

Operation

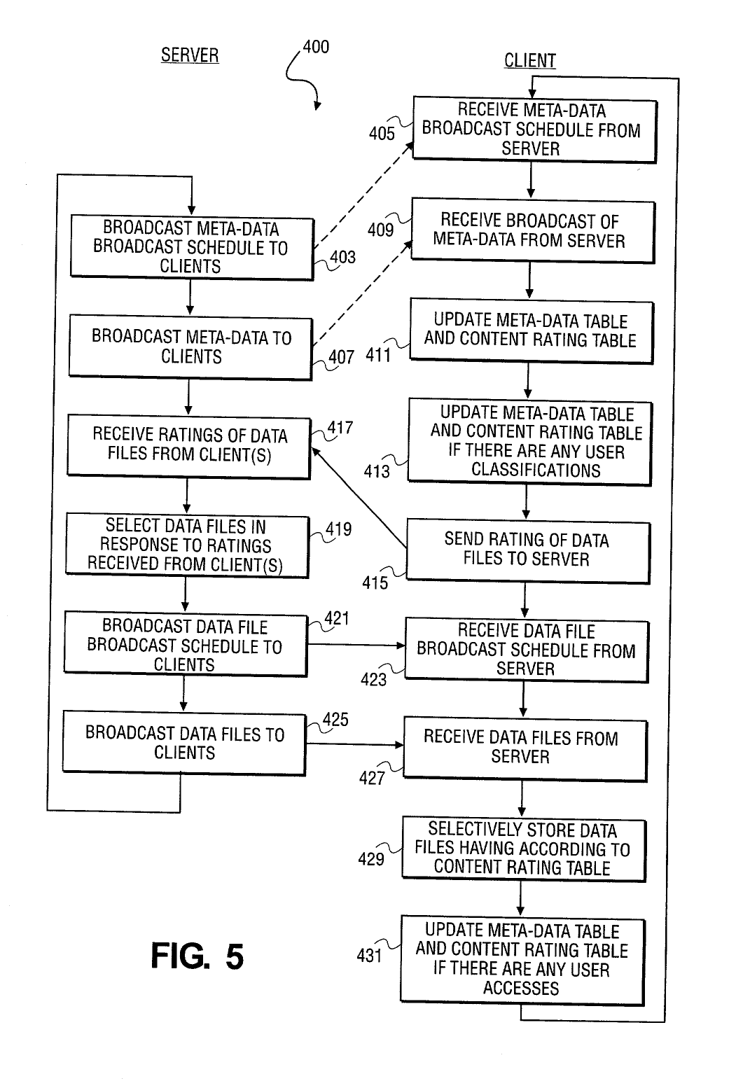

FIG. 5 depicts a flow diagram illustrating the flow of events performed in a server and a client of a service provider broadcast system 300, for example, as depicted in FIG. 4, for combining existing broadcast content with a digital broadcasting/caching service. As referred to herein, a digital broadcasting/caching service describes a broadcast system wherein the system selects one or more data files to broadcast to one or more client system. Once the one or more data files are selected, the data files are broadcast to the one or more client systems, which selectively store the one or more data files. The data files are stored by the client systems in order to enable viewing at a later date and time by a user. This digital broadcasting/caching service is provided by the service provider broadcast system 300 as depicted in FIG. 4.

However, the service provider broadcast system 300 can be utilized to broadcast content in conjunction with the broadcast service system 100 as depicted in FIGS. 1 and 4. Consequently, content selected by the service provider broadcast system 300, for example, in response to client rankings, is transmitted to one or more client systems using bandwidth provided by the broadcast service system 100. However, in order to best utilize bandwidth provided by the broadcast service system 100, the service provider broadcast system 300 may eliminate one or more duplicate or overlapping data files to be broadcast by the broadcast service system 100.

The service provider broadcast system 300 will then select a portion of the broadcast data files 101 and the first plurality of data files (selected provider/broadcast data files). Overlapping files between the selected provider/broadcast data files and the broadcast data files 101 are removed from the selected provider/broadcast data files to form the provider data files 151. Once formed, the provider data files 151 are broadcast to the one or more client systems utilizing the broadcast service system 100 and are selectively stored by the one or more client systems based on content rating tables. In addition, as the overlapping data files are eventually broadcast by the broadcast service system 100, the one or more client systems may capture one or more of the overlapping data files. Alternatively, the service provider broadcast system may broadcast one or more of the overlapping data files.

At process block 403, a service provider server 303 may broadcast a meta-data broadcast schedule to the one or more clients. In one embodiment, the meta-data broadcast schedule indicates some point in the future when the actual meta-data of the present invention is going to be broadcast by the server. Alternatively, the client systems may use known ports such as, for example, those used in the program and system information protocol (PSIP), DVB, service advertising protocol (SAP) or the like, to listen for upcoming service announcements from the server.

Otherwise, each client 305, 307 and 309 can contain a known scheduling service, which accepts requests to wake up, or be activated, at a specific time to receive the information broadcast by the server. This scheduling service enables the client to wake up at a specified time and select a specified service. For example, in one embodiment, this selection process can be accomplished by tuning to a specific frequency, such as for example in an Advanced Television Systems Committee (ATSC) or a DVB transponder or the like. The selection process can be based on a set of data, such as for example multi-cast Internet protocol (IP) addresses, which define a service.

Alternatively, a client application can register, for example, with a client signaling system to receive signals from a specific content provider. The client signaling system maintains a table of applications associated with specific content providers. For example, information from the server is broadcast over known addresses such that each client can use the known address.

At process block 405 client systems may receive the meta-data broadcast schedule from the service provider server 303. In one embodiment, client systems 305, 307 and 309 capture and process this pre-broadcast information in order to determine when to wake-up and receive content, where to receive the content and which content to receive. Alternatively, when the meta-data broadcast schedule is received by the client, a registered application in the client is notified to receive the meta-data broadcast schedule.

At process block 407, meta-data is broadcast to one or more client system. The meta-data includes descriptions of a first plurality of data files available from the service provider system 300, and a second plurality of data files (broadcast data files 101) to be broadcast by a broadcast service system 101. The meta-data from the first plurality of data files and the second plurality of data files may be broadcast at separate times and in different formats. At process block 409, the client receives the broadcast of meta-data from the server. At process block 411, the client system then updates a meta-data table and a content rating table. In one embodiment, a meta-data table and a content rating table are updated and maintained internally or locally by each client system. In addition, a user of the client system may optionally classify any one or more of the plurality of data files that are described by the received meta-data. As will be discussed, the meta-data table and content rating table are updated by the client if there are any user classifications. This is shown in FIG. 5 with process block 413.

At process block 415, the client may send the ratings of the data files to the server. In one embodiment, each client in the broadcast network sends the ratings for all of the plurality of data files that are described by the meta-data broadcast earlier from the server. Alternatively, each client sends all or part of the content rating table maintained on the client system. However, the client need not rate the data files in order for the service provider/broadcast system 300 to select the provider data files 151 and the overlapping data files.

At process block 417, the server may receive the ratings of the data files from the client(s) in the broadcast system. At process block 419, the server then selects the data files having, for example, the highest ratings as determined by the client systems. Alternatively, the system 300 may rank the data files based on box office returns, public opinion polls, movie awards (e.g., the Academy Awards), user requests or the like. In one embodiment, the server includes processing to aggregate all of the ratings received from the clients. Consequently, the data files are sorted according to the aggregated ranking.

In one embodiment, the data files that are to be broadcast are then determined in response to the ranking. As a result, the server broadcasts the most appropriate or relevant data files for the customer base or clients. For instance, in one embodiment, the data files having the highest ranking are broadcast and the data files having the lowest ranking are not broadcast. In one embodiment, the broadcast schedule is also determined in response to the ranking. For instance, the highest ranked data files are broadcast before lower ranked data files.

In another embodiment, the highest ranked data files are broadcast at a time assumed most appropriate to send highly ranked data files. For instance, assume an example where Thursday evenings during primetime is the most important time for a broadcaster to have the highest ratings for broadcast. In this example, a server in accordance with teachings of the present invention would broadcast the highest-ranking data file on Thursday evening during primetime. It is appreciated that a server may determine a broadcast schedule in other ways.

In one embodiment, the data files to broadcast, and/or the broadcast schedule are determined dynamically by the server in response to the ratings received from the client(s) in accordance with teachings of the present invention. Therefore, in one embodiment, broadcast schedules can change over time depending on which data files are available from the server and which content or data files are accessed and/or classified by the clients.

Once the data files to be broadcast and the broadcast schedule are determined by the server, process block 421 shows that the server then broadcasts the data file broadcast schedule to the clients. Process block 423 shows that the client then receives the data file broadcast schedule from the server.

In one embodiment, the clients wake-up to receive a data file broadcast schedule from the server. The data file broadcast schedule indicates, for example, a future time in which specific data files, which were described in the previously broadcast meta-data, will be broadcast by the server. At process block 425, the data files are then actually broadcast from the server to the clients at the time specified in the data file broadcast schedule. Process block 427 shows that the client receives the broadcast of data file broadcast schedule from the server. At process block 429, client-side filtering is provided by the client selectively storing data files according to the content rating table. In another embodiment, client-side filtering is provided by the client selectively waking up to selectively receive data files broadcast from the server according to the content rating table. In this embodiment, the client then stores the data files that were selectively received by the client according to the content rating table.

Process block 431 shows that the client then updates the meta-data table and content rating table if there are any user accesses of the stored data files. As described herein, a user access may include a user interacting with, viewing, watching, listening to, reading, consuming, etc., a data file. For instance, one example of a user accessing a data file may be the user watching a particular movie or listening to a particular song provided by one of the stored data files in client. In one embodiment, a user access will result in the meta-data table and content rating table on the client being updated locally.

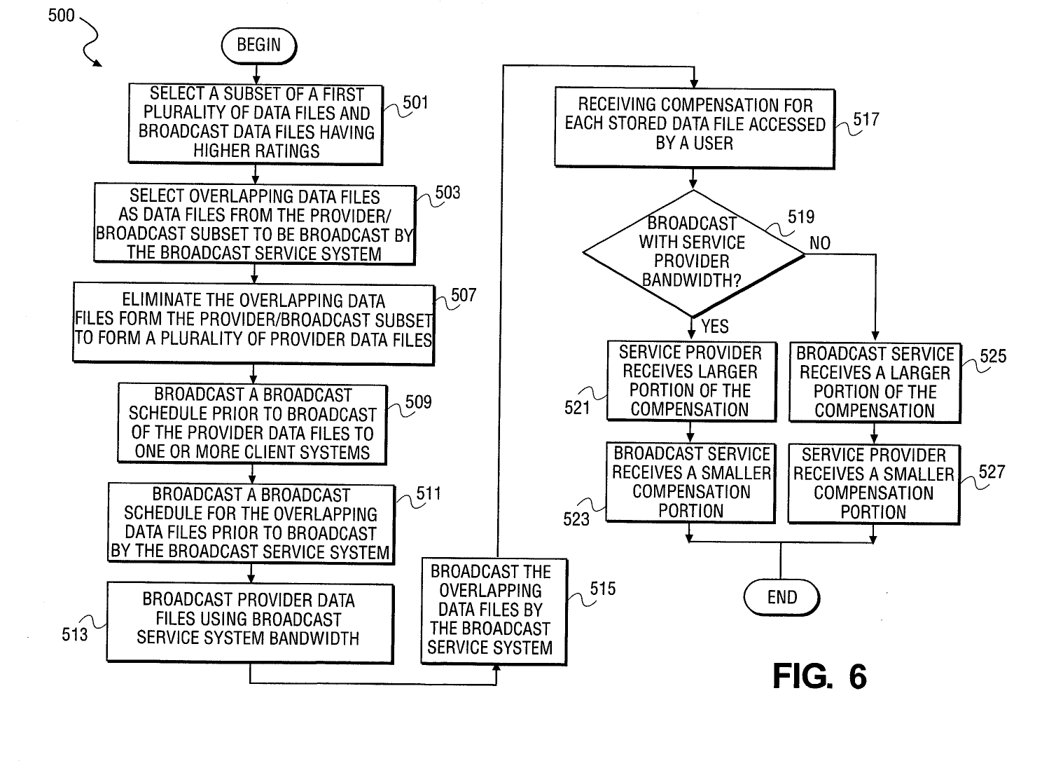

FIG. 6 depicts a more detailed flow chart illustrating the selection of the provider data files 151 by a service provider broadcast systems, for example, as depicted in FIG. 4. At process block 501, a service provider server 303 selects a subset of the first plurality of data files and the broadcast data files 101 having higher rankings based, for example, on the rankings received from the one or more client systems. In other words, the system 300 selects a portion of these files (selected provider/broadcast data files) which are, for example, most popular to the one or more client systems based on rankings received from the one or more client systems.

At process block 503, the service provider server 303 selects overlapping data files as data files contained within the selected provider/broadcast data files, which are to be broadcast by the broadcast service system 100. In other words, data files within the selected provider/broadcast portion should not be broadcast by both the broadcast service provider system 300 as well as the broadcast service system 100. Consequently, at process block 507, the service provider server 303 eliminates the overlapping data files from the provider/broadcast data file subset to form the plurality of provider data files 151 which are broadcast by the service provider system 300 to the one or more client systems.

At process block 509, the service provider broadcast server 300 broadcasts a broadcast schedule prior to broadcast of the provider data files 151. The provider data files 151 will each be broadcast to the one or more client systems as a group in order to enable storage of the provider data files 151 based on client system content rating tables. However, the overlapping data files may be broadcast at various times, depending on the broadcast service system 100 broadcast schedule. Accordingly, at process block 511, the service provider server 303 broadcasts a broadcast schedule for the overlapping data files prior to broadcast by the broadcast service system 100. Consequently, utilizing the broadcast schedule, the one or more client systems can determine whether to store a data file contained within the overlapping data files, once it is available, based on a stored content rating table. However, the system 300 may choose to broadcast one or more of the overlapping data files instead of awaiting broadcast of the one or more files by the broadcast service system 100.

At step 513, the service provider server 303 broadcasts the provider data files 151 to the client systems utilizing service provider bandwidth. For example, in an embodiment of the present invention, the service provider broadcast system utilizes bandwidth provided by the broadcast service system 100 in order to broadcast data files to the one or more client systems via antenna 111. However, the service provider broadcast system may broadcast data files either via antenna 311, via network 313 or via satellite broadcast. At process block 515, the broadcast service server 103 broadcasts the overlapping data files to the one or more client systems. As described above, data files within the overlapping data files will not be sent as a group. These data files are broadcast at the times scheduled by the broadcast service system 100.

Utilizing a service provider broadcast system in accordance with the teachings of the present invention, broadcast service systems may purchase a service from a service provider broadcast system in order to optimize pay-per view royalties and subscription revenues. As such, content available from the broadcast service system may be combined with the cached content provided by the service provider broadcast system. Consequently, at process block 517, the service provider broadcast system 300 receives compensation for each stored data file accessed by a user. At process block 519, it is determined whether the data file accessed by the user was broadcast to the user using service provider broadcast system bandwidth or broadcast service system bandwidth. When service provider bandwidth was used, at process block 521, the service provider broadcast system receives a larger portion of the compensation, while at step 523, the broadcast service system receives a smaller compensation portion. Alternatively, when broadcast service system bandwidth was used to broadcast a data file, the broadcast service system receives a larger portion of the compensation at process block 525, while at process block 527, the service provider broadcast system receives a smaller compensation portion.

In a further embodiment, a user wishing to view a data file stored in a client platform is billed for viewing the selected data file based on a content provider of the selected data file. The content provider is generally one of the broadcast service system 100, the service provider broadcast system 300, or a premium content provider including, for example, HBO, Showtime, Cinemax, the Movie Channel, Stars, or the like. As such, the system 300 determines a content provider for each stored content data file. In addition, stored content data files presented to a user for viewing on a pay-per-view basis may include attribution for the content provider of the stored content including, for example, the display of a content provider logo, as well as additional information. In another embodiment, each stored content data file is placed in a common depository. Consequently, a user desiring to access stored content data files is required to access a single location, namely the common depository in order to select from the stored data files which may be available on a pay-per-view basis or already paid for via a subscription fee.

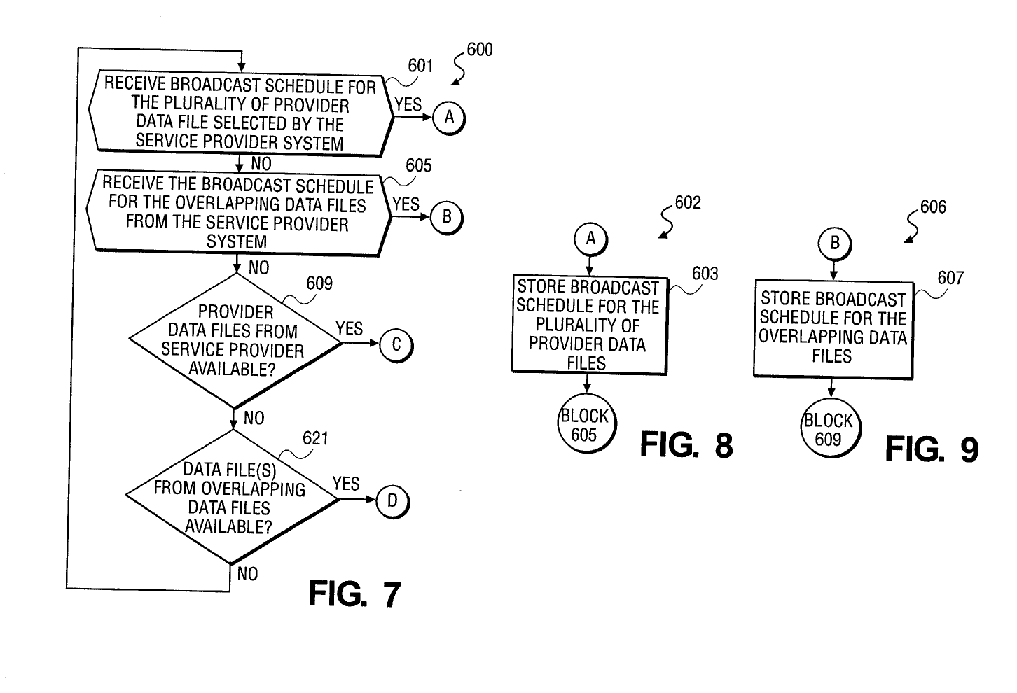

FIG. 7 is a flow diagram illustrating events performed by a client system for selectively storing received data files. At process block 601, a client system receives a broadcast schedule for the plurality of provider data files 151 selected by the service provider broadcast system 300. As described above, data files available from the service provider broadcast system 300 are referred to as a first plurality of data files, while the final data files selected by the system 300 are referred to as provider data files 151. On the other hand, data files that the broadcast service system 100 will be broadcasting at a future time to the one or more client systems are referred to as a second plurality of data files 101 or broadcast data files 101. In essence, the service provider broadcast system 300 will broadcast the provider data files 151, since these files are highly regarded by the users based on, for example, the received rankings and are not going to be broadcast by the broadcast service system 100.

At process block 602, the client system stores the broadcast schedule for the plurality of provider data files 151 (FIG. 8). At process block 605, it is determined whether a broadcast schedule for the overlapping data files was received from the service provider system 300. The overlapping data files include a subset of the data files from the second plurality of data files or broadcast data files 101, which the broadcast service 100 will broadcast and that received high rankings from the received ranking lists. As such, the overlapping data files include high ranking data files which are to be broadcast by both the service provider system 300 as well as the broadcast service system 100, but also highly ranked data files which are only to be broadcast by the broadcast service system 100.

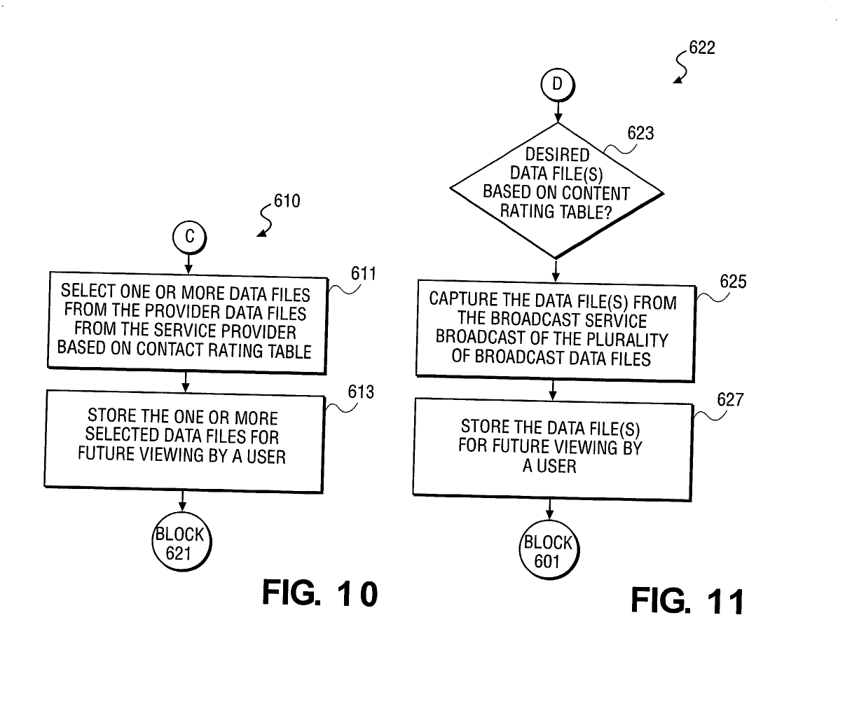

At process block 607, the client system stores a broadcast schedule for the overlapping data files (FIG. 9). At process block 609, it is determined whether the provider data files 151 are available. At process block 611, the client selects one or more data files from the provider data files 151 based on a content rating table (FIG. 10). Generally, the portion of the provider data files selected by the service provider system 300 will include data files which received an overall popularity rating from the one or more client systems. However, each user of the client system will be different and will generally select a subset of the data files within the provider data files 151. Once selected, at process block 613, the client stores the one or more selected data files for future viewing by a user (FIG. 10).

At process block 621, it is determined whether data files from the overlapping data files are available. At process block 623, it is determined whether a data file available from the overlapping data files is desired by the client system based on the content rating table (FIG. 11). As described above, data files contained within the overlapping data files may have various broadcast dates and times. Consequently, the client systems will utilize the broadcast schedules to, for example, activate during the date and time of the data file, assuming the data file is desired by the client system. At process block 625, the client system captures the data file from the broadcast service broadcast of the broadcast data files 101 (FIG. 11). At process block 627, the client system stores the data files for future viewing by a user (FIG. 11).

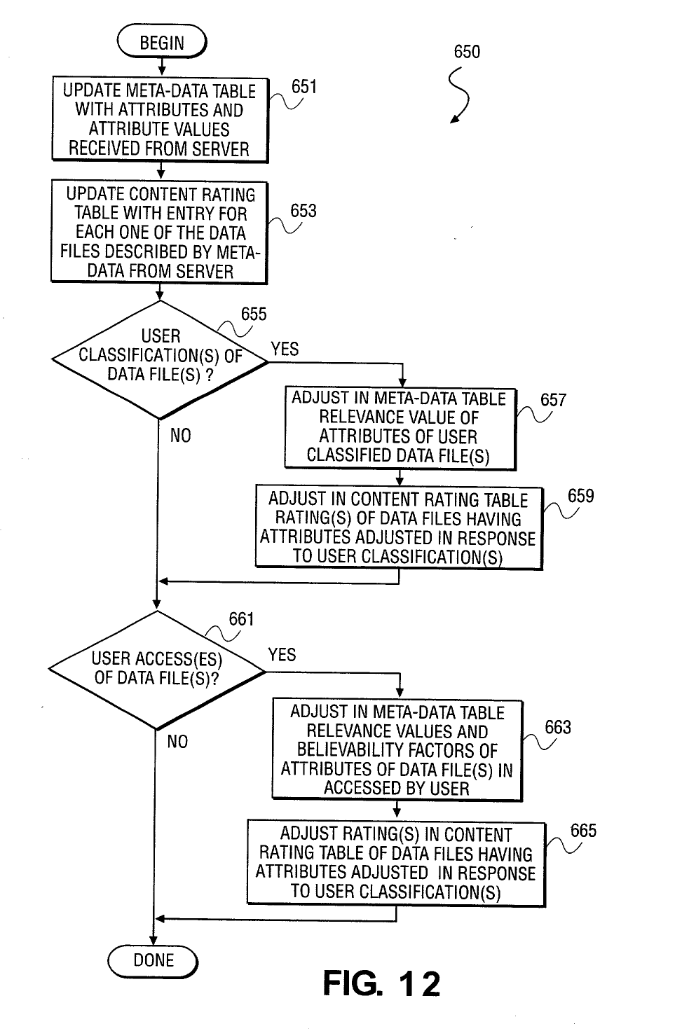

FIG. 12 is a more detailed flow diagram illustrating one embodiment of the flow of events 650 in a client when processing meta-data broadcasted from a server and updating and maintaining a meta-data table and a content rating table in accordance with the teachings of the present invention. The embodiments described illustrate generation of content rating tables in response to user access of data files. However, those skilled in the art will appreciate that the client system may rate the data files based on box office returns, public opinion polls, movie awards (e.g., the Academy Awards), user requests or the like. In particular, process block 653 shows that a meta-data table is updated with attributes and attribute values included in the meta-data broadcasted from the server. Process block 605 shows that the content rating table is then updated with an entry for each one of the data files described by the meta-data broadcast from the server.

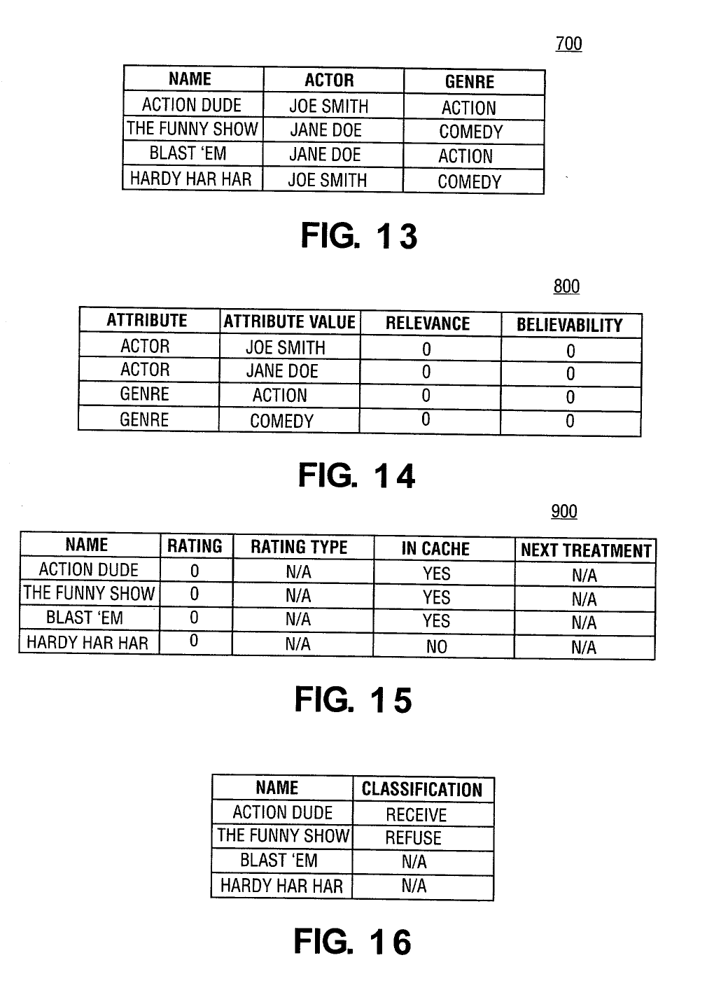

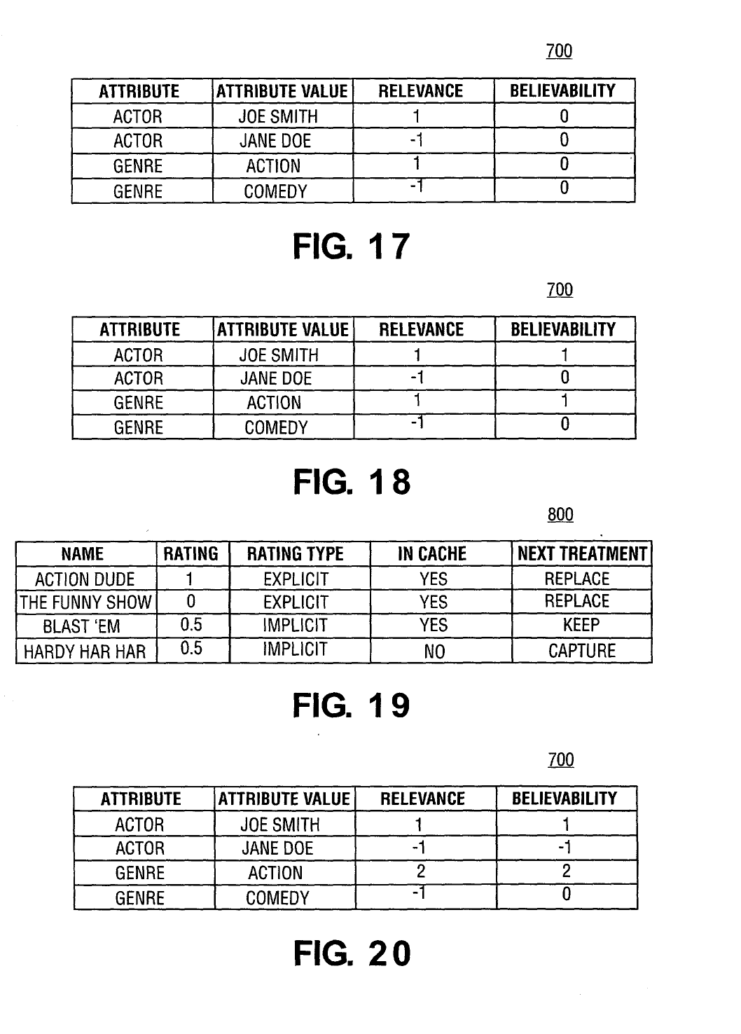

To help illustrate the meta-data aspect of the present invention, FIGS. 13-20 illustrate meta-data and content rating tables in accordance with the teachings of the present invention. FIG. 13 is an example of one embodiment of meta-data 700, which may be broadcast by the broadcast server 103 to the clients 305, 307 and 309. For explanation purposes, it is assumed that the data files broadcast by the broadcast server 103 in this example are audio/video files such as for example movies or TV programming. As mentioned above, data files may be other types of files such as for example but not limited to audio, graphics, text, multi-media or the like.

In the illustrated embodiment, meta-data 700 in FIG. 13 shows that four movies, or data files, will be broadcast later by server 103. These movies shown in this example are “Action Dude,” “The Funny Show,” “Blast 'Em” and “Hardy Har Har.” Meta-data 700 includes attributes and attribute values that describe each one of the movies to be broadcast later by server 103. In the example illustrated, two attributes are provided to describe each movie in meta-data 700. The attributes shown in FIG. 13 are “Actor” and “Genre.” It is appreciated that other embodiments of the present invention may include different attributes as well as or attributes values. Referring back to the particular example shown in FIG. 13, “Action Dude” is an “action” movie featuring actor “Joe Smith.” “The Funny Show” is “comedy” movie featuring actress “Jane Doe.” “Blast 'Em” is an “action” movie featuring actor “Jane Doe.” “Hardy Har Har” is a “comedy” movie featuring “Joe Smith.”

FIG. 14 is an example of one embodiment of meta-data table 800, which is updated and maintained locally by each client 305, 307 and 309. In the illustrated embodiment, meta-data table 800 in FIG. 14 has been populated with the data included in meta-data 700, which was broadcasted earlier from server 103. In one embodiment, meta-data table 800 includes a list of attributes, attribute values and corresponding relevance values and believability factors. In particular, meta-data table 800 includes attribute values “Joe Smith,” “Jane Doe,” “action,” and “comedy.” At this time, the relevance values and believability factors for attribute values “Joe Smith,” “Jane Doe,” “action,” and “comedy” are all zero in FIG. 14. As will be shown, in one embodiment, the relevance values and believability factors of the present invention will be updated and maintained as the user interacts with the client system.

In one embodiment, the relevance values in meta-data table 800 are indicators as to how relevant the associated attribute and attribute values are for predicting a particular user's behavior. For instance, the relevance value indicates how likely it is for the user to watch a particular movie because of this particular attribute value, within a range of values such as for example from −10 to 10. In one embodiment, the believability factors in meta-data table 800 are weighting factors to be applied to specific attribute and attribute value pairs when rating or predicting whether a user will actually access a particular data file having that particular attribute value. In one embodiment, believability factors in meta-data table 800 are within a range of values such as for example from −10 to 10.

FIG. 15 is an example of one embodiment of a content rating table 900, which is updated and maintained locally by each client 305, 307 and 309. In the illustrated embodiment, content rating table 900 includes a list of the data files described in meta-data 700 as well as any additional data files that are currently stored or cached locally by the client.

In one embodiment, data files may be stored locally by the client in for example memory 205, storage 211 or in a locally accessible network by machine 201 of FIG. 3. For purposes of this disclosure, data files being stored locally by the client may also be interpreted to include a data file stored “locally” by the client in a known network storage configuration, separate from the server. For purposes of this disclosure, the data file being stored or cached locally by the client is to be interpreted as the data file being stored for later access, retrieval or consumption. In one embodiment, the local cache of the present invention is considered to be a first level cache. Thus, the local cache the present invention is sized accordingly to increase the possibility of a single hit.

Assuming an audio/video data file, a movie is stored locally by the client. After a user watches the movie, the storage space occupied by the movie is generally considered to be available for storage of another movie to be broadcast sometime later. Thus, it is appreciated that the local cache of the client system is modeled as the single use system, e.g. fire and forget, in accordance with teachings of the present invention. In one embodiment, it is assumed that when a user accesses a data file, it is not likely that the user will want to access that same data file again. If a user has not watched a particular movie, the storage space occupied by that movie is generally considered not to be available for storage of another movie. However, if there is no additional storage space available and a higher rated movie is to be broadcast, the lower rated unwatched movie may be replaced by the higher rated movie.

Referring back to the embodiment of content rating table 900 shown FIG. 15, each movie also has an associated rating, a rating type indicator, an in cache indicator and a next treatment indicator. In one embodiment, the rating indicates a rating value for the associated data file. The rating value in one embodiment may either be explicitly input by a user or implicitly generated by the client system by processing meta-data associated with that particular data file. For example, a relatively high rating value predicts that the particular data file may be of interest to the user. Conversely, a relatively low rating value predicts that the particular data file is unlikely to be of interest to the user.

In one embodiment, the in cache indicator indicates whether that particular data file is currently stored or cached locally by the client. In the embodiment illustrated in FIG. 15, the movies “Action Dude,” “The Funny Show” and “Blast 'Em” already exist in the local storage of the client system. Conversely, the movie “Hardy Har Har” has not been stored in the local storage of the client system in the example illustrated in FIG. 15.

In one embodiment, the next treatment indicator is used to track future actions to be taken for the particular data file. For example, if a movie has already been watched by the user, the next treatment indicator would indicate “replace” to indicate that the storage space occupied by that particular movie is available for storage of another movie. However, if the movie has not yet been watched by the user, the next treatment indicator would indicate “keep.” In addition, if the movie has not been stored locally by the client and if the rating value predicts that this particular movie may be of interest to the user, the next treatment indicator would indicate “capture.” While if the movie has not yet been broadcast by the server and the rating predicts that this movie is unlikely to be of interest to the user, the next treatment indicator would indicate “ignore.”

Referring again to FIG. 12, decision block 657 shows that it is then determined whether there is a user classification of any of the data files. Referring briefly to FIG. 16, a user classifies some of the movies, as described by meta-data 700. In particular, the user has expressed interest in the movie “Action Dude” by indicating that he or she wishes to receive that movie. In addition, the user has expressed that he or she does not have any interest in the movie “The Funny Show” by indicating that he or she refuses that movie. However, the user has not provided any information or classification regarding any of the remaining movies.

Referring back to FIG. 12, if the user has classified any of the data files, process block 659 shows that the relevance values of the particular attributes of the classified data files are updated in meta-data table 800. Process block 661 shows that the ratings of data files having attribute values with relevance values that were adjusted in response to the user classification(s) are also adjusted. For example, referring to meta-data table 800 in FIG. 9, the relevance values for attribute values “Joe Smith” and “action” are adjusted to reflect that the user explicitly expressed an interest in “Action Dude.” However, if the user has not classified any data files, process blocks 409 and 411 are skipped.

Referring again to FIG. 12, if the user accesses any of the data files, as determined in decision block 663, process block 665 shows that the relevance values and the believability factors of the particular attributes of the user accessed data files are updated in meta-data table 800. Process block 417 shows that the ratings of data files having attribute values with relevance values that were adjusted in response to the user access are also adjusted. In one embodiment, each time a user accesses or interacts with particular data file, the believability factor of the attribute values of that film are adjusted or updated. For example, FIG. 18 shows a meta-data table 800 that is updated or adjusted in response to the user access of “Action Dude.” In this example, the believability factors of “Joe Smith” and “action” are increased since the relevance values for these attribute values were greater than zero. If the user has not accessed any data files, process blocks 415 and 417 are skipped.

FIG. 19 shows content rating table 900, which is updated in response to the user access of “Action Dude,” as described in process block 667. As mentioned earlier, content rating table 900 is also updated as described in process block 661. As shown in content rating table 900 of FIG. 19, “Action Dude” has a rating value of 1. The rating type of “Action Dude” is “explicit” because the user explicitly classified “Action Dude,” as described above in connection with FIG. 16. The in cache indicator indicates that “Action Dude” is presently locally stored by the client system. The next treatment indicator indicates replace because the user has already watched “Action Dude.” It is noted that ratings values may be determined in other ways in accordance with the teachings of the invention, which consider the relevance values and believability factors for each of the attribute values of a data file.

As shown in meta-data table 800 of FIG. 20, the relevance values and believability factors are updated for the attribute values of unclassified data files that are accessed. For instance, assume that the user now watches the movie “Blast 'Em,” which the user did not classify. Recall from FIG. 13 that the movie “Blast 'Em” features “Jane Doe” and is an “action” movie. As shown in FIG. 18, the relevance value of “Jane Doe” was less than zero, or −1, prior to the user watching “Blast 'Em.” Nevertheless, the user watched “Blast 'Em,” despite the fact that it featured actress “Jane Doe.” Accordingly, the believability factor of the “Jane Doe” attribute the value is adjusted downward since this particular attribute value now appears less likely or relevant when predicting a user's viewing habits. However, the relevance value and believability factor for the attribute value “action” are adjusted upwards since “action” had a relevance value of greater than zero prior to the user watching “Blast 'Em.” Thus, in this example, the relevance value is adjusted upwards from 1 to 2 and the believability factor is also adjusted upwards from 1 to 2. Therefore, the content rating table 800 of FIG. 20 now predicts that “action” movies are movies that the user is more likely to watch.

It is appreciated that the user is not required to classify data files explicitly in order for the meta-data table 800 and content rating table 900 to be updated in accordance with the teachings of the present invention. As a result, the content rating table over time will more accurately predict data files in which the user is interested.

In one embodiment, the data files in which the user is predicted implicitly to be most interested as well as the data files in which the user explicitly classified an interest will be the data files that are cache locally on the client system. In effect, the movies that the user is most likely to want to watch are automatically stored locally, and therefore available “on demand,” without the user having to explicitly request these movies in advance or explicitly specify criteria used to identify the movies.

Alternate Embodiments

Several aspects of one implementation of a service provider broadcast system for combining existing broadcast content with cached content have been described. However, various implementations of the service provider broadcast system provide numerous features including, complementing, supplementing, and/or replacing the features described above. Features can be implemented as part of the server or as part of the user's computer system in different implementations. In addition, the foregoing description, for purposes of explanation, used specific nomenclature to provide a thorough understanding of the invention. However, it will be apparent to one skilled in the art that the specific details are not required in order to practice the invention.

It is to be understood that even though numerous characteristics and advantages of various embodiments of the present invention have been set forth in the foregoing description, together with details of the structure and function of various embodiment of the invention, this disclosure is illustrative only. Changes may be made in detail, especially matters of structure and management of parts within the principles of the present invention to the full extent indicated by the broad general meaning of the terms in which the appended claims are expressed. For example, certain subassemblies are only described within detail with one such embodiment. Nevertheless, it is recognized that such subassemblies may be used in other embodiments of the present invention.

In addition, although an embodiment described herein is directed to a video broadcast, it will be appreciated by those skilled in the art that the teaching of the present invention can be applied to other systems. In fact, systems for broadcasting audio, graphics, text, multi-media files or the like are within the teachings of the present invention, without departing from the scope and spirit of the present invention. The embodiments described above were chosen and described in order to best explain the principles of the invention and its practical applications. These embodiments were chosen to thereby enable others skilled in the art to best utilize the invention and various embodiments with various modifications as are suited to the particular use contemplated.

The present invention provides many advantages over known techniques. The present invention enables a service provider broadcast system to increase the breadth of content offerings due to the fact that existing broadcast systems may have rights to content that the system does not. By combining the set of content that can be captured, the system can generate revenue from content which it might not otherwise be able to broadcast. In addition, by combining the most appropriate movies for the consumers all in one place in order to get the best movies to create a common repository. In doing so, the system also optimizes bandwidth. For example, for movies which would already be sent over the same broadcast network, there is no need for the system to pay for rebroadcasting this content. Instead, the system can focus on using its scarce bandwidth for other content which not may be broadcast by the broadcast service system in a timely manner.

Having disclosed exemplary embodiments and the best mode, modifications and variations may be made to the disclosed embodiments while remaining within the scope of the invention as defined by the following claims.

What is claimed is:

1. A method, comprising:
broadcasting meta-data to one or more client systems, including descriptions of a first plurality of data files available from a service provider system and a second plurality of data files to be broadcast by a broadcast service system;
rating the first plurality of data files and second plurality of data files; and
broadcasting a portion of the first plurality of data files to the one or more client systems in response to the ratings and the second plurality of data files to be broadcast by the broadcast service.

2. The method of claim 1 further comprising:
receiving ratings of the first plurality of data files and second plurality of data files from the one or more client systems;
selecting a portion of the first and second plurality of data files which have having higher ratings based on the received ratings;
determining overlapping data files as data files from the selected portion of the first and second plurality of data files to be broadcast by the broadcast service system; and
eliminating, from the selected portion of the first plurality of data files, the overlapping data files to form the portion of the first plurality of data files to be broadcast to the one or more client systems by the service provider.

3. The method of claim 2 further comprising:
broadcasting a service provider broadcast schedule of the portion of the first plurality of data files prior to broadcasting the portion of the first plurality of data files; and
broadcasting a broadcast schedule for the overlapping data files prior to broadcast by the broadcast service system.

4. The method of claim 1 further comprising broadcasting a broadcast schedule of the meta-data prior to broadcasting the meta-data to the one or more client systems.

5. The method of claim 1 further comprising:
receiving compensation for each stored data file accessed by a user; and
dividing the compensation between the service provider system and the broadcast service system based on a source of each data file, such that the source of the data file is one of the service provider system and the broadcast service system and receives a larger compensation portion and a non-source receives a smaller compensation portion.

6. A method, comprising:
receiving meta-data, the meta-data including descriptions of a first plurality of data files available from a service provider system and a second plurality of data files to be broadcast by a broadcast service system;
rating, in response to a content rating table, at least one of the first and second plurality of data files described by the meta-data, the content rating table generated responsive to a user;
receiving a portion of the first plurality of data files broadcast by the service provider system and the second plurality of data files broadcast by the broadcast service system; and
storing, based on the content rating table, one or more of a portion of the second plurality of data files broadcast by the broadcast service system and one or more of the portion of the first plurality of data files broadcast by the service provider system.

7. The method of claim 6, further comprising:
transmitting the ratings of the at least one of the first and second plurality of data files to the service provider system.

8. The method of claim 6 further comprising:
receiving a broadcast schedule of the meta-data, the client system activated in response to the broadcast schedule;
receiving a first broadcast schedule for the portion of the first plurality of data files of data files prior to receiving the portion of the first plurality of data files;
receiving a second broadcast schedule for the portion of the second plurality of data files prior to receiving the second plurality of data files in order to store one or more of the portion of the first plurality of data files and one or more of the portion of the second plurality of data files.

9. The method of claim 6, further comprising:
receiving a selection from a user for a stored data file;
determining a content provider for the selected data file, wherein the content provider is one of the broadcast service system, the service provider system, and a premium content provider; and
billing the user a predetermined amount for selection of the stored data based on the content provider of the selected data file.

10. The method of claim 6, further comprising:
determining a content provider for each stored data file, wherein the content provider is one of the broadcast service system, the service provider system, and a premium content provider, such that attribution is given to the content provider of each stored content data file when presented to a user.

11. The method of claim 6, wherein the storing of data files further comprises:
placing each stored data file in a common repository irrespective of a content provider of the data file, such that a user can access a single location for selecting stored content data files.

12. A method, comprising:
receiving meta-data, the meta-data including descriptions of a first plurality of data files available from a service provider system and a second plurality of data files to be broadcast by a broadcast service system;
rating, in response to a content rating table, at least one of the first and second plurality of data files described by the meta-data, the content rating table generated responsive to a user;
receiving a broadcast schedule for a portion of the second plurality of data files broadcast by the broadcast service system;
selectively receiving, based on the content rating table, a portion of the first plurality of data files broadcast by the service provider system;
storing one or more of the portion of the first plurality of data files broadcast by the service provider system; and
when data files from the portion of the second plurality of data files are available based on the broadcast schedule, storing one or more of the data files based on the content rating table.

13. The method of claim 12, further comprising:
transmitting the ratings of the at least one of the first and second plurality of data files to the service provider system.

14. The method of claim 12, further comprising:
receiving a meta-data broadcast schedule broadcast by the service provider system, a client system activated in response to the meta-data broadcast schedule.
receiving a service provider broadcast schedule of the first plurality of data files prior to selectively receiving the portion of the first plurality of data files.

15. An apparatus, comprising:
a processor having circuitry to execute instructions;
a communications interface coupled to the processor, the communications interface to broadcast data to one or more client systems, and to receive data from the one or more client systems;
a storage device coupled to the processor, having sequences of instructions stored therein, which when executed by the processor cause the processor to:
broadcast meta-data to one or more client systems, including descriptions of a first plurality of data files available from a service provider system and a second plurality of data files to be broadcast by a broadcast service system,
rate the first plurality of data files and second plurality of data files, and
broadcast a portion of the first plurality of data files to the one or more client systems in response to the ratings and the second plurality of data files to be broadcast by the broadcast service system.

16. The apparatus of claim 15 wherein the processor is further caused to select a portion of the first and second plurality of data files, which have higher ratings based on the received ratings.

17. The apparatus of claim 15, wherein the processor is further caused to:
receive ratings of the first plurality of data files and second plurality of data files from the one or more client systems,
select a portion of the first and second plurality of data files which have having higher ratings based on the received ratings,
determine overlapping data files as data files from the selected portion of the first and second plurality of data files to be broadcast by the broadcast service system,
eliminate, from the portion of the first and second plurality of data files, the overlapping data files to form the portion of the first plurality of data files to be broadcast to the one or more client systems,
broadcast a service provider broadcast schedule of the portion of the first plurality of data files prior to broadcasting the portion of the first plurality of data files, and
broadcast a broadcast schedule for the overlapping data files prior to broadcast by the broadcast service system.

18. The apparatus of claim 15, wherein the processor is further caused to broadcast a meta-data broadcast schedule of the meta-data prior to broadcasting the meta-data to the one or more client systems.

19. An apparatus, comprising:
a processor having circuitry to execute instructions;
a communications interface coupled to the processor, the communications interface to receive data broadcast from a service provider system, and to transmit data to the service provider system;
a storage device coupled to the processor, having sequences of instructions stored therein, which when executed by the processor cause the processor to:
receive meta-data, the meta-data including descriptions of a first plurality of data files available from a service provider server system and a second plurality of data files to be broadcast by a broadcast service system,
rate, in response to a content rating table, at least one of the first and second plurality of data files described by the meta-data, the content rating table generated responsive to a user,
receive a portion of the first plurality of data files broadcast by the service provider system and data files from a portion of the second plurality of data files broadcast by the broadcast service system, and
store, based on the content rating table, one or more of the data files from the portion of the second plurality of data files and one or more of the portion of the first plurality of data files.

20. The apparatus of claim 19 wherein the processor is further caused to:
transmit the ratings of the at least one of the first and second plurality of data files to the service provider system.

21. The apparatus of claim 19 wherein the processor is further caused to:
receive a meta-data set broadcast schedule broadcast by the service provider server system, the client system activated in response to the meta-data broadcast schedule;
receive a first broadcast schedule for the first portion of the first plurality of data files prior to receiving the portion of the first plurality of data files, and
receive a second broadcast schedule for the portion of the second plurality of data files, prior to receiving data files from the portion of the second plurality of data files, in order to store one or more of the portion of the first plurality of data files and one or more of the portion of the second plurality of data files.

22. An apparatus comprising:
a processor having circuitry to execute instructions;
a communications interface coupled to the processor, the communications interface to receive data broadcast from a service provider system, the communications interface further coupled to transmit data to the service provider system;
a storage device coupled to the processor, having sequences of instructions stored therein, which when executed by the processor cause the processor to:
receive meta-data, the meta-data including descriptions of a first plurality of data files available from a service provider system and a second plurality of data files to be broadcast by a broadcast service system,
rate, in response to a content rating table, at least one of the first and second plurality of data files described by the meta-data, the content rating table generated responsive to a user,
receive a broadcast schedule for a portion of the second plurality of data files broadcast by the broadcast service system,
selectively receive, based on the content rating table, a portion of the first plurality of data files broadcast by the service provider system,
store one or more of the portion of the first plurality of data files broadcast by the service provider system, and
when data files from the portion of the second plurality of data files are available based on the broadcast schedule, store one or more data files from the portion of the second plurality of data files.

23. The apparatus of claim 22, wherein the processor is further caused to:
transmit the ratings of the at least one of the first and second plurality of data files to the service provider system.

24. The apparatus of claim 22, wherein the processor is further caused to:
receive a meta-data broadcast schedule broadcast by the service provider system, the client system activated in response to the meta-data broadcast schedule; and
receive a service provider broadcast schedule of the first plurality of data files prior to selectively receiving the portion of the first plurality of data files.

25. A machine-readable medium having instructions stored thereon, which when executed by a processor cause the processor to:
broadcast meta-data to one or more client systems, including descriptions of a first plurality of data files available from a service provider system and a second plurality of data files to be broadcast by a broadcast service system,
rate the first plurality of data files and second plurality of data files, and
broadcast a portion of the first plurality of data files to the one or more client systems in response to the ratings and the second plurality of data files to be broadcast by the broadcast service system.

26. The machine-readable medium of claim 25 wherein the processor is further caused to:
receive ratings of the first plurality of data files and second plurality of data files from the one or more client systems,
select a portion of the first and second plurality of data files which have having higher ratings based on the received ratings,
determine overlapping data files as data files from the selected portion of the first and second plurality of data files to be broadcast by the broadcast service system, and
eliminate, from the selected portion of the first and second plurality of data files, the overlapping data files to form the portion of the first plurality of data files to be broadcast to the one or more client system.

27. The machine-readable medium of claim 25 wherein the processor is further caused to:
combine the ratings received from the client systems, if ratings are received from more than one client system, to generate an overall ratings list of the first and second plurality of data files.

28. A machine-readable medium having instructions stored thereon, which when executed by a processor cause the processor to:
receive meta-data, the meta-data including descriptions of a first plurality of data files available from a service provider server system and a second plurality of data files to be broadcast by a broadcast service system,
rate, in response to a content rating table, at least one of the first and second plurality of data files described by the meta-data, the content rating table generated responsive to a user,
receive a portion of the first plurality of data files broadcast by the service provider system and data files from a portion of the second plurality of data files broadcast by the broadcast service system, and
store, based on the content rating table, one or more of the data files from the portion of the second plurality of data files broadcast by the broadcast service system and one or more of the portion of the first plurality of data files broadcast by the service provider system.

29. The machine-readable medium of claim 28 wherein the processor is further caused to:
transmit the ratings of the at least one of the first and second plurality of data files to the service provider system.

30. The machine-readable medium of claim 28 wherein the processor is further caused to:
remove data files stored on a client system once viewed by a user, and
replace deleted data files with additional data files broadcast by the service provider system and the broadcast service system using the content rating table.

31. The machine-readable medium of claim 28 wherein the processor is further caused to:
receive a selection from a user for a stored data file;
determine a content provider for the selected data file, wherein the content provider is one of the broadcast service system, the service provider system, and a premium content provider; and
bill the user a predetermined amount for selection of the stored data based on the content provider of the selected data file.

32. The machine-readable medium of claim 28 wherein the processor is further caused to:
determine a content provider for each stored data file, wherein the content provider is one of the broadcast service system, the service provider system, and a premium content provider, such that attribution is given to the content provider of each stored content data file when presented to a user.

33. The machine-readable medium of claim 28 wherein the instruction for storing the data files further causes the processor to:
place each stored data file in a common repository irrespective of a content provider of the data file, such that a user can access a single location for selecting stored content data files.

34. A system, comprising:
a service provider broadcast server; and
one or more client systems coupled to the service provider broadcast server,
wherein meta-data is broadcast to the one or more client systems, the meta-data including descriptions of a first plurality of data files available from the service provider broadcast server and a second plurality of data files to be broadcast by a broadcast service system,
wherein the one or more client systems rate, in response to a content rating table, one or more of the first and second plurality of data files described by the meta-data, the content rating table generated responsive to data files previously accessed,
wherein the one or more client systems transmit, to the service provider broadcast server, the ratings of the first and second plurality of data files,
wherein the service provider server selects a portion of the first and second plurality of the data files in response to the ratings received from the one or more client systems, and
wherein the service provider system further broadcasts the selected portion of the first plurality of data files to the one or more client system.

35. The system of claim 34, wherein each one of the one or more client systems selectively store data files from the selected portion of the first and second plurality of data files in response to a content rating table associated with each respective one of the one or more of client systems.

36. The system of claim 34 wherein each one of the one or more client systems selectively receive data files from the selected portion of the first and second plurality of data files in response to a content rating table associated with each respective one of the one or more of client systems.
